(19) United States
(12) Patent Application Publication
(10) Pub. No.: US 2025/0219934 A1
(43) Pub. Date: Jul. 3, 2025

(54) PITSTOP: A FAULT HANDLING APPROACH FOR DATA CENTER NETWORKS WITH END-TO-END FLOW CONTROL

(71) Applicant: Intel Corporation, Santa Clara, CA (US)

(72) Inventor: Hossein FARROKHBAKHT, Toronto (CA)

(21) Appl. No.: 19/082,001

(22) Filed: Mar. 17, 2025

(51) Int. Cl. H04L 45/28; H04L 41/0663

(52) U.S. Cl. CPC H04L 45/28; H04L 41/0663

(57) ABSTRACT

Examples described herein relate to a forwarding element. In some examples, the forwarding element include circuitry that is to: based on detection of a faulty link in a path through forwarding elements to a destination device, direct a packet to a network interface device to cause the packet to traverse a second path to the destination device to bypass the faulty link to the destination device.

Networks provide connectivity among multiple processors, memory devices, and storage devices for distributed performance of processes. In an end-to-end flow control in a network, packets are categorized into payload packets and control packets. Payload packets carry payload information, such as data. Control packets include Acknowledgements (ACKs) and negative acknowledgements (NACKs). A destination sends an ACK to a sender based on receipt of a payload packet at a destination, but sends a NACK when the destination fails to receive a payload packet.

### BRIEF DESCRIPTION OF THE DRAWINGS

FIG. 1 depicts an example forwarding element.

FIG. 2 depicts an example operation of a network.

FIG. 3 depicts an example operation of a network.

FIG. 4 depicts an example process.

FIG. 5 depicts an example process.

FIG. 6 depicts an example network interface device.

FIG. 7 depicts an example computing system.

### DETAILED DESCRIPTION

For source routing, a sender can compute an entire path of a packet from sender network interface device to destination network interface device through one or more forwarding elements. The path can be represented as a sequence of output ports to traverse, whereby forwarding elements on the path select an output port from the sequence based on the number of hops incurred. However, when ACKs/NACKs encounter a faulty link on the return path towards corresponding senders, the forwarding element connected to the faulty link is unable to select another path to evade the faulty link. Thus, for source-routing, ACKs/NACKs may not reach to the corresponding senders and senders may not re-transmit packets. In some cases, senders may not receive a notification of a faulty link and can re-use a path that includes a faulty link to transmit other packets and such other packets may be dropped.

Various examples can route at least control packets (e.g., ACKs or NACKs) and/or payload packets to evade faulty links in a network of forwarding elements, by routing the control packets and/or payload packets to a network interface device (e.g., Ethernet bridge). The network interface device can assign a new path to the packet to evade the faulty link. The new path can identify output ports to route the packet from the network interface device to a destination network interface device. The network interface device can re-inject the packet to the fabric of forwarding elements to forward the packet to its destination. Various examples provide for the payload packets to evade the faulty link without the need for requesting re-transmission of the packet by its sender. Various examples can be used at least in various radix router configurations and various diameter network topologies (e.g., PolarFly (2-diameter), PolarStar (3-diameter), and SlimFly (2-diameter)) to route packets from sender to destination.

Various examples can provide a virtual network for packets that are source routed and redirected to avoid a faulty link. The virtual network can include allocation of buffer space and port bandwidth for routing of packets that are ejected and re-injected to avoid a faulty link. The virtual network can include one or more virtual channels (VCs) so that packets of different flows are assigned exclusive or prioritized buffer space and port bandwidth when the packets are ejected and re-injected to avoid a faulty link. For example, when a packet (e.g., payload or control) encounters a faulty link, the packet can be transferred from a payload VC (or control VC) to an ejection VC. When the packet is re-injected to the fabric, the packet can traverse a re-direction VC to the destination.

Various examples can apply to packets that are source routed or destination routed. For destination routing, the forwarding elements determine a forwarding path based on the destination IP address in a packet, instead of the source specifying the route through a list of hops.

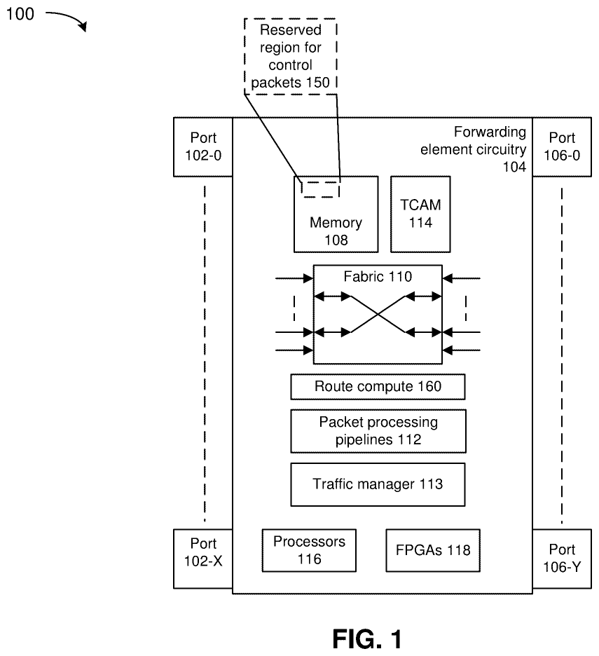

FIG. 1 depicts an example forwarding element. Various examples of forwarding element system 100 can be used in a network on chip (NoC) to perform operations described herein to cause a re-route of a packet to its destination based on detection of a faulty link. A NoC can include forwarding elements, network interface devices, links, and controllers. However, forwarding elements can be part of a mesh or off-chip network (e.g., Ethernet local area network (LAN) or wide area network (WAN)).

Forwarding element circuitry 104 can route packets, flits, or frames of any format or in accordance with any specification from one or more of ports 102-0 to 102-X to one or more of ports 106-0 to 106-Y (or vice versa), where X and Y are integers. One or more of ports 102-0 to 102-X can be connected to a network of one or more interconnected devices. Similarly, one or more of ports 106-0 to 106-Y can be connected to a network of one or more interconnected devices.

In some examples, switch fabric 110 can provide routing of packets from one or more ingress ports 102-0 to 102-X for processing prior to egress from forwarding element 104. Switch fabric 110 can be implemented as one or more multi-hop topologies, where example topologies include torus, butterflies, buffered multi-stage, shared memory switch fabric (SMSF), among other implementations. SMSF can be a switch fabric connected to ingress ports and egress ports in the switch, where ingress subsystems write (store) packet segments into the fabric's memory, while the egress subsystems read (fetch) packet segments from the fabric's memory.

Memory 108 can be configured to store packets received at ingress ports 102-0 to 102-X prior to egress from one or more ports. In some examples, a portion of buffer space (e.g., region 150) in memory 108 and bandwidth of ports 102-0 to 102-X and 106-0 to 106-Y can be allocated for a virtual channel to store and/or forward packets that were re-directed to avoid a faulty link and are to be forwarded. Allocating a region 150 for re-directed packets can provide a quality of service for the packets and potentially reduce latency of transmission of the packets to the sender.

Packet processing pipelines 112 can include ingress and egress packet processing circuitry to respectively process ingressed packets and packets to be egressed. Packet processing pipelines 112 can determine which port to transfer packets or frames to using a table that maps packet characteristics with an associated output port. Packet processing pipelines 112 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 112 can implement access control list (ACL) or packet drops due to queue overflow.

Packet processing pipelines 112, processors 116, FPGAs 118, and/or route compute (RC) circuitry 160 can be configured to detect a faulty link and re-direct a source routed packet to a network interface device to adjust the source routing of the packet to avoid a faulty link, as described herein. In some examples, packet processing pipelines 112, processors 116, FPGAs 118, and/or route compute (RC) circuitry 160 can be configured to adjust a route of a packet to avoid the faulty link and reach a destination.

Configuration of operation of packet processing pipelines 112, including its data plane, can be programmed using Programming Protocol-independent Packet Processors (P4), C, Python, Broadcom Network Programming Language (NPL), or x86 compatible executable binaries or other executable binaries.

Traffic manager 113 can perform hierarchical scheduling and transmit rate shaping and metering of packet transmissions from one or more packet queues. Traffic manager 113 can perform congestion management such as flow control, congestion notification message (CNM) generation and reception, priority flow control (PFC), and others.

In some examples, forwarding element 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, network interface device, switch, router, and/or receiver network interface device can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, router and switch can be used interchangeably. In some examples, a forwarding element or forwarding device can include a router and/or switch.

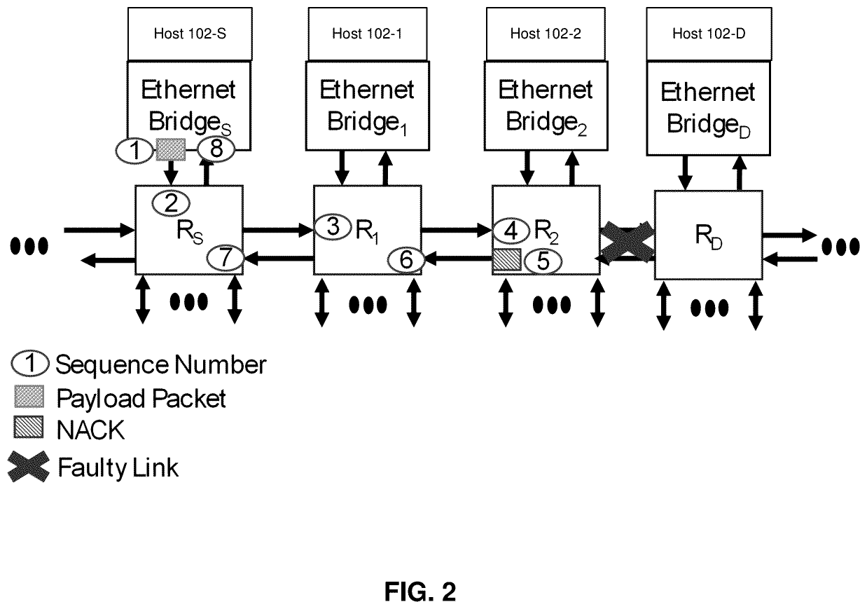

FIG. 2 depicts an example operation of a system. Host system 102-S can transmit a packet to host 102-D via a path through forwarding elements R_{S} to R_{D}. At (1), Ethernet bridge_{S} can transmit the packet to forwarding element R_{S}. Ethernet bridge_{S} can transmit the packet to a destination of Ethernet bridge_{D} and maintain a copy of the packet to re-transmit, if the packet is dropped. Based on its source routing field, from (2) to (4), the packet traverses the forwarding elements R_{S}, R₁, and R₂. A faulty link exists between R₂ and R_{D} and packets cannot traverse from R₂ to R_{D} due to conditions such as a broken cable, excessive error rate, congestion at one or more input or output queues or ports of R₂ or R_{D}, or other conditions. As the link between R₂ and R_{D} is broken, forwarding element R₂ drops the packet and, at (5), issues a NACK, that identifies the defective output port, to Ethernet bridges. From (6) to (8), the NACK traverses the routers, R₁ and Rₛ, and is ejected to Ethernet bridges. The NACK can request Ethernet bridge_{S} to re-transmit the packet to the destination.

When a control packet (e.g., ACKs or NACKs) encounter a faulty link on the return path towards their destination (e.g., Ethernet bridge_{S}) and when source-routing is employed, the forwarding element connected to the faulty link may be unable to select another path for the control packet to evade the faulty link. Thus, ACKs/NACKs may not reach to their destination and packet senders are not instructed to re-transmit ACKs/NACKs, as the sender (e.g., Ethernet bridge_{D}) may not keep a copy of the ACKs/NACKs. As a result, ACKs/NACKs may get lost when they encounter faulty links.

For payload or control packet type, when source-routing is employed, various examples can bypass the faulty link. Packets that encounter a faulty link can be transferred to an Ethernet bridge (e.g., network interface device) connected to a forwarding element with a faulty link in a path of the packet. If there are multiple Ethernet bridges connected to the forwarding element, in some examples, the least congested Ethernet bridge can be selected to forward the packet (e.g., based on the credit counters). The selected Ethernet bridge can access the destination field of the packet header and determine an updated routing path from a routing table to avoid the faulty link. The updated routing path can include the output ports of associated forwarding elements to the destination. The selected Ethernet bridge can insert the updated routing path in the packet header. After updating the routing field of the packet header, the selected Ethernet bridge can store the packet in a designated injection queue to be re-injected to the network through a virtual network to the destination Ethernet bridge.

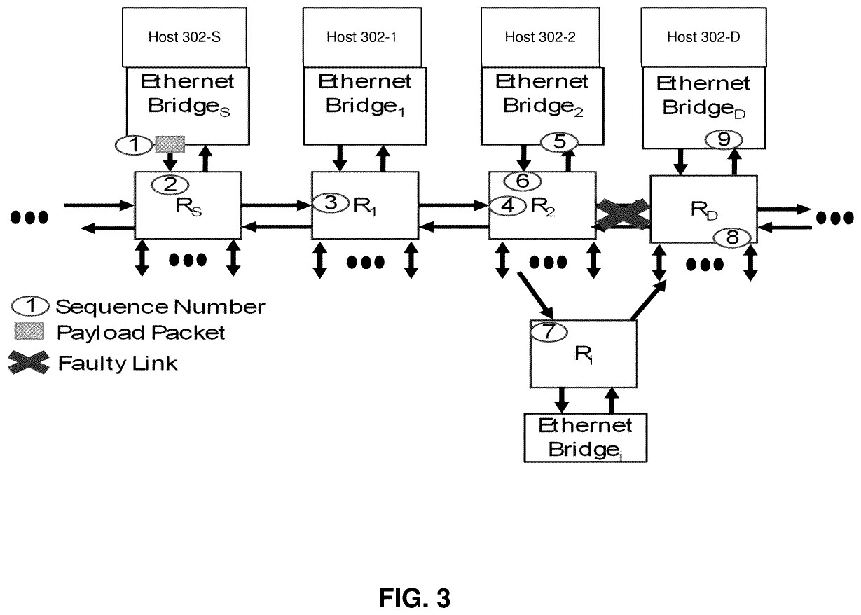

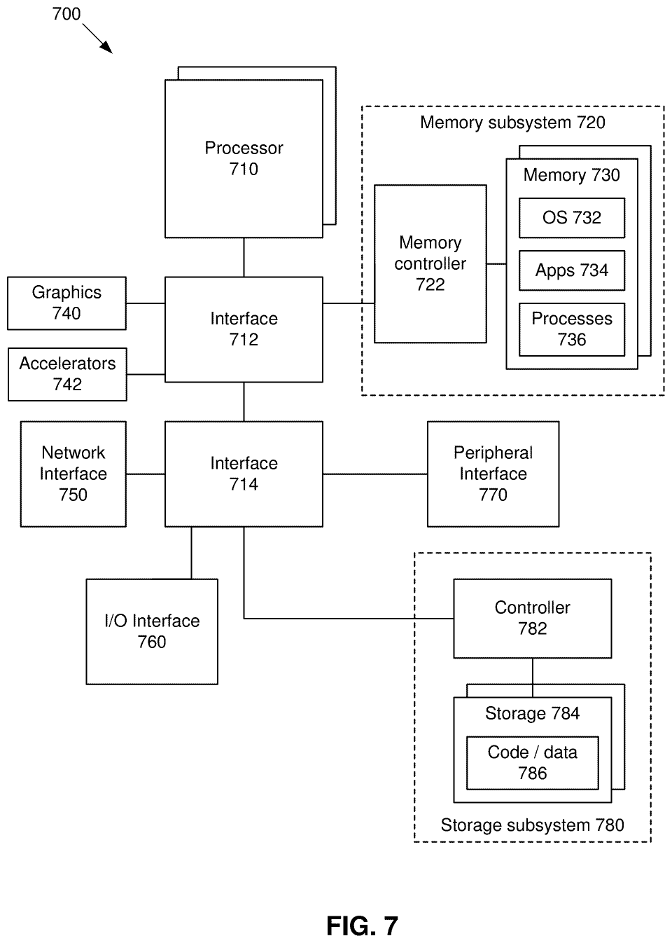

FIG. 3 depicts an example operation of a system. Various examples of host systems 302-S, 302-1, 302-2, and 302-D are described herein at least with respect to FIG. 7. Host system 302-S can transmit a packet to host 302-D by requesting Ethernet bridge_{S} to transmit the packet to Ethernet bridge_{D}. The packet can include a payload packet and/or a control packet. A payload packet can include data to be processed. A control packet can include one or more of: an ACK, NACK, network telemetry data, error reporting data, or others. In some examples, network telemetry data can include data described at least in: “In-band Network Telemetry (INT) Dataplane Specification, v2.0,” P4.org Applications Working Group (February 2020); Alternate-Marking Method for Passive and Hybrid Performance Monitoring (AM-PM) (e.g., Internet Engineering Task Force (IETF) RFC 9341 (2022); IETF draft-lapukhov-dataplane-probe-01, “Data-plane probe for in-band telemetry collection” (2016); IETF draft-ietf-ippm-ioam-data-09, “In-situ Operations, Administration, and Maintenance (IOAM)” (Mar. 8, 2020); and Active Network Telemetry (ANT); or others. In-situ Operations, Administration, and Maintenance (IOAM) records operational and telemetry information in the packet while the packet traverses a path between two points in the network. IOAM discusses the data fields and associated data types for in-situ OAM. In-situ OAM data fields can be encapsulated into a variety of protocols such as NSH, Segment Routing, Geneve, IPv6 (via extension header), or IPv4.

Ethernet bridge_{S}, Ethernet bridge₁, Ethernet bridge₂, and Ethernet bridge_{D} can transmit and receive packets using any protocol (e.g., Ethernet, a shared memory protocol (e.g., Compute Express Link (CXL), or others). Ethernet bridge_{S}, Ethernet bridge₁, Ethernet bridge₂, and Ethernet bridge_{D} can be implemented as one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU), or others.

Ethernet bridge_{S} can transmit a packet to Ethernet bridge_{D} via forwarding elements R_{S}, R₁, R₂, and R_{D}. Various examples of forwarding elements R_{S}, R₁, R₂, and R_{D} can include one or more of: a switch, router, network interface device, SmartNIC, infrastructure processing unit (IPU), data processing unit (DPU), or edge processing unit (EPU), or others. In some examples, a network on chip (NoC) can include forwarding elements R_{S}, R₁, R₂, and R_{D}.

An example of operations can be as follows. At (1), the packet is injected to the network and from (2)-(4), the packet traverses the forwarding elements until the reaches the faulty link. In this example, a faulty link exists between forwarding elements R₂ and R_{D}. For example, when a link between forwarding elements or between a forwarding element and a network interface is faulty or goes down, a forwarding element (e.g., forwarding element R2 or R1) can transmit a fault signal along with the output port identifier (ID) to network interface devices (e.g., Ethernet bridge_{S}, Ethernet bridge₁, Ethernet bridge₂, and/or Ethernet bridge_{D}). The network interface devices can record these fault signals in a fault table. If output port i is faulty, the network interface device sets its value to one, indicating the faulty link. The forwarding element can indicate a link is no longer faulty to the network interfaces.

Because the packet cannot traverse the source routed path due to the fault, at (5), the packet leaves a virtual channel (VC) path and forwarding element R₂ ejects the packet to Ethernet bridge₂. Ethernet bridge₂ revises the routing field of the packet to evade the path from R₂ to R_{D}. A virtual network (VN) can be allocated to the re-directed packet whereby queue space (e.g., a region for packets or payloads of packets), ingress and egress port bandwidth, and/or egress packet arbitration are allocated to prioritize storage, ingress, and/or egress of the re-directed packet. For example, the forwarding element can modify the re-directed packet to include an indicator of re-direction in its header (e.g., one or more bits) that indicates to a receiver network interface device or forwarding element that the packet is a re-directed packet and to process the re-directed packet as described herein.

In some examples, Ethernet bridge₂ can store a copy of the redirected packet in case the redirected packet is dropped by a forwarding element or another Ethernet bridge so that Ethernet bridge₂ can, based on receipt of a NACK, re-transmit the redirected packet along the same path as previously transmitted or redirect the packet to yet another path to the destination Ethernet bridge.

At (6), Ethernet bridge₂ can transmit the re-directed packet with updated routing field to forwarding element R₂. Various examples of adjusting the routing field of the re-directed packet are described herein. At (7), Ethernet bridge₂ can transmit the re-directed packet with updated routing field to forwarding element Rᵢ. At (8), forwarding element Rᵢ can forward the re-directed packet to forwarding element R_{D}. At (9), forwarding element R_{D} can forward the re-directed packet to Ethernet bridge_{D}, a destination network interface device for the re-directed packet.

Note that the re-directed packet can encounter another faulty link along the new path. In this case, a forwarding element can redirect the redirected packet to yet another Ethernet bridge to re-update a routing path of the redirected packet and then re-inject the re-directed packet with updated routing path into the network for transmission to the destination Ethernet bridge. Accordingly, a risk of dropping a control packet can be reduced as a faulty link can be evaded and the packet that is source routed can be re-routed to avoid the faulty link.

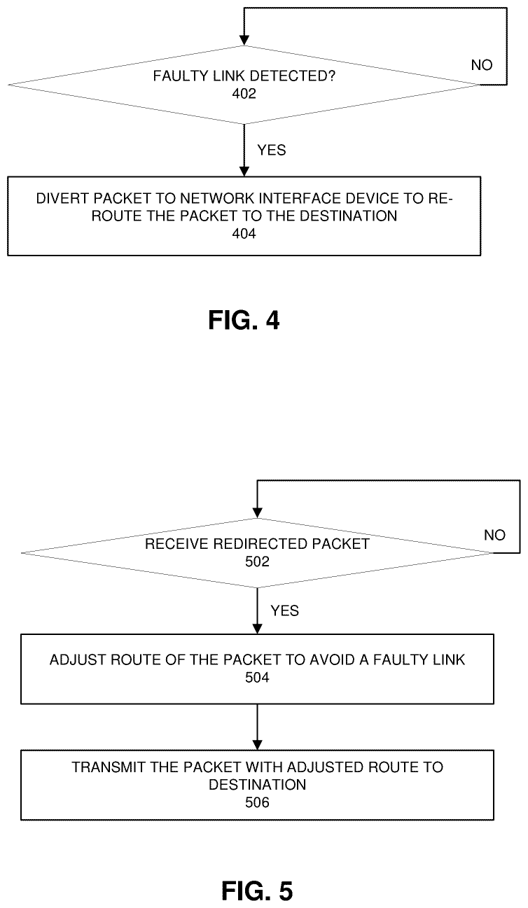

FIG. 4 depicts an example process. The process can be performed by a forwarding element. At 402, a determination can be made of detection of a faulty link can occur. A faulty link can include a connection between ports of forwarding elements or a forwarding element and a network interface device. Based on detection of a faulty link, the process can proceed to 404. Based on not detecting a faulty link, the process can repeat 402. At 404, a packet directed to the faulty link can be redirected to a network interface device to re-route the packet to avoid the faulty link to the destination. In some examples, buffer space and port bandwidth can be exclusively allocated for redirected packets in the network interface device and routers to avoid dropping redirected packets due to congestion.

FIG. 5 depicts an example process. The process can be performed by a network interface device. At 502, a determination can be made of receipt of a packet that is re-directed by a forward element to avoid a faulty link. The re-directed packet can be identified by being received by a network interface device having an address or identifier that is different than the destination address of the re-directed packet or an indicator that identifies that packet as re-directed. The faulty link can be identified by a signal from a forwarding element. Based on detection of a packet to be re-directed, the process can proceed to 504. Based on not detecting a re-directed packet, the process can repeat 502. At 504, the network interface device can update a routing path of the re-directed packet to avoid the faulty link and arrive at the destination network interface device. At 506, the network interface device can transmit the packet to its destination with an updated routing field.

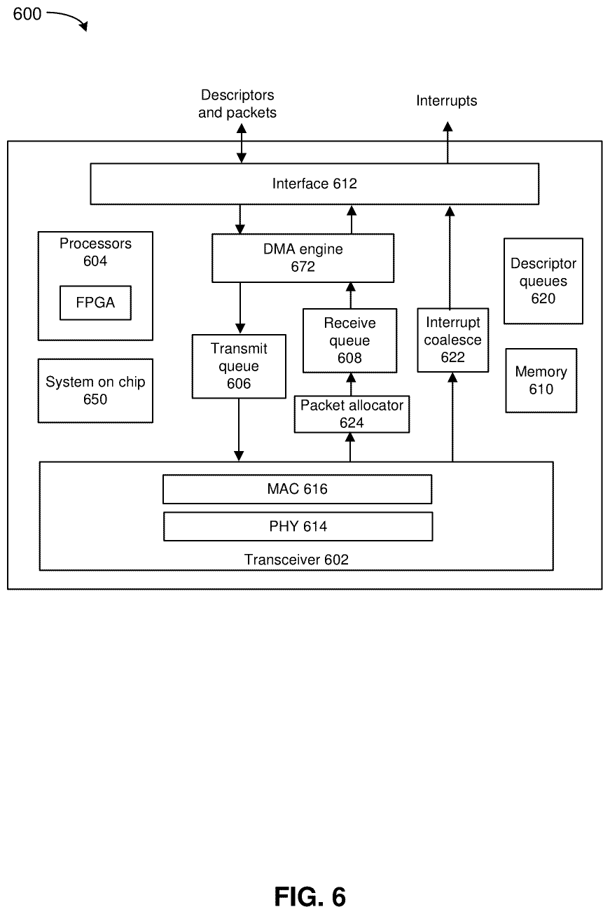

FIG. 6 depicts an example network interface device. In some examples, circuitry of network interface device can be utilized to re-direct a packet to avoid a faulty link, as described herein. In some examples, network interface device 600 can be implemented as a network interface controller, network interface card, a host fabric interface (HFI), or host bus adapter (HBA), and such examples can be interchangeable. Network interface device 600 can be coupled to one or more servers using a bus, PCIe, CXL, or Double Data Rate (DDR). Network interface device 600 may be embodied as part of a system-on-a-chip (SoC) that includes one or more processors, or included on a multichip package that also contains one or more processors.

Some examples of network interface device 600 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface device 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to assemble data to be transmitted into packets, that include destination and source addresses along with network control information and error detection hash values.

Processors 604 can perform operations of a route compute unit that accesses a routing table which indicates an appropriate output port for a destination network interface. The routing table can identify a route for a packet through one or more forwarding elements to a destination network interface, where the route avoids a faulty link. The routing table can be populated by the firmware and can be changed during the runtime.

Processors 604 can examine a destination ID of a received packet in the packet header and if the destination ID differs from the network interface ID of the receiver network interface device, processors 604 determine that the packet was ejected due to a faulty link by a forwarding element. Then, using the fault table and the route compute unit, processors 604 can select another output port for the packet to avoid the faulty link. Network interface device 600 can re-inject the packet over the selected output port to continue on its path towards the destination.

Processors 604 can be any a combination of a: processor, core, graphics processing unit (GPU), field programmable gate array (FPGA), application specific integrated circuit (ASIC), or other programmable hardware device that allow programming of network interface 600. For example, a “smart network interface” can provide packet processing capabilities in the network interface using processors 604.

Processors 604 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 604, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with PCI, PCI Express, PCI-x, Serial ATA, and/or USB compatible interface (although other interconnection standards may be used).

FIG. 7 depicts a system. The system can use examples to configure a forwarding element to re-direct packets to a non-destination network interface device to re-route the packet to avoid a faulty link, as described herein. In some examples, processor 710, graphics 740, one or more of accelerators 742, and/or network interface 750 can decompress or decrypt data and store an entirety of decompressed or decrypted data or a strict subset of decompressed or decrypted data or validate decompression or decryption operations, described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die.

Accelerators 742 can be a fixed function or programmable offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as static random-access memory (SRAM), dynamic random-access memory (DRAM), or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 732 or driver can advertise capability of network interface 750 to adjust a routing path of a packet based on indication of a faulty link in a path of the packet, as described herein. In some examples, OS 732 or driver can enable or disable network interface 750 to adjust a routing path of a packet based on indication of a faulty link in a path of the packet, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. In some examples, network interface 750 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory.

Some examples of network interface 750 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 750 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. A non-volatile memory (NVM) device is a memory whose state is determinate even if power is interrupted to the device.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a first interface to an input port; a second interface to an output port; and circuitry coupled to the first interface and the second interface, wherein: based on detection of a faulty link in a path through forwarding elements to a destination device, the circuitry is to direct a packet to a network interface device to cause the packet to traverse a second path to the destination device, the second path is to bypass the faulty link to the destination device, and the network interface device comprises a direct memory access (DMA) circuitry, host interface to a processor, and network interface.

Example 2 includes one or more examples, wherein the packet comprises an acknowledgement of packet receipt (ACK) or negative ACK (NACK).

Example 3 includes one or more examples, wherein the faulty link comprises a communicative coupling between at least two of the forwarding elements of the circuitry.

Example 4 includes one or more examples, wherein the network interface device is communicatively coupled to the circuitry and at least one processor core.

Example 5 includes one or more examples, wherein: based on detection of a second faulty link in a third path through the forwarding elements to a second destination device, the circuitry is to direct a second packet to a fourth path within the circuitry to the second destination device and the second packet comprises a data packet.

Example 6 includes one or more examples, and includes the forwarding element coupled to the circuitry, wherein the forwarding element comprises one or more of: a router or a switch.

Example 7 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

Example 8 includes one or more examples, and includes a method that includes: based on receipt of a packet with source routing and directed to a faulty link, a forwarding element sending the packet toward a network interface device and the network interface device adjusting the source routing of the packet to avoid the faulty link and transmitting the packet toward a destination of the packet, wherein: the network interface device comprises a direct memory access (DMA) circuitry, host interface to a processor, and a network interface.

Example 9 includes one or more examples, wherein the packet comprises a control packet and/or a data packet.

Example 10 includes one or more examples, wherein the source routing of the packet is to indicate a sequence of output ports to traverse.

Example 11 includes one or more examples, wherein the network interface device is communicatively coupled to one or more cores.

Example 12 includes one or more examples, wherein the forwarding element comprises one or more of: a router or a switch.

Example 13 includes one or more examples, and includes the network interface device detecting the packet is to be re-directed based on a destination address of the packet not matching an address of the network interface device and based on detecting the packet is to be re-directed and an identifier of a faulty link from the forwarding element, the network interface device adjusting the source routing of the packet to avoid the faulty link.

Example 14 includes one or more examples, wherein the forwarding element is part of a network on chip (NoC), mesh, or off-chip network.

Example 15 includes one or more examples, and includes reserving port bandwidth and buffer space for packets re-directed to avoid the faulty link and forwarding the re-directed packet through the reserved port bandwidth and from the reserved buffer space.

Example 16 includes one or more examples, and includes at least one non-transitory computer-readable medium, comprising instructions stored thereon, that if executed by one or more processors, cause the one or more processors to: configure a network interface device to: based on receipt of a packet directed to a faulty link by source routing and received from a forwarding element, adjust source routing of the packet to avoid the faulty link and transmit the packet toward a destination of the packet, wherein the network interface device comprises a direct memory access (DMA) circuitry, host interface to a processor, and a network interface.

Example 17 includes one or more examples, and includes instructions stored thereon, that if executed by one or more processors, cause the one or more processors to: reserve port bandwidth and buffer space for packets re-directed to avoid the faulty link and forward the re-directed packet through the reserved port bandwidth and from the reserved buffer space.

Example 18 includes one or more examples, wherein the packet comprises a control packet and/or a data packet.

Example 19 includes one or more examples, wherein the source routing of the packet is to indicate a sequence of output ports to traverse.

Example 20 includes one or more examples, wherein the network interface device is communicatively coupled to one or more cores.

1. An apparatus comprising:
a first interface to an input port;
a second interface to an output port; and
circuitry coupled to the first interface and the second interface, wherein:
based on detection of a faulty link in a path through forwarding elements to a destination device, the circuitry is to direct a packet to a network interface device to cause the packet to traverse a second path to the destination device,
the second path is to bypass the faulty link to the destination device, and
the network interface device comprises a direct memory access (DMA) circuitry, host interface to a processor, and network interface.

2. The apparatus of claim 1, wherein the packet comprises an acknowledgement of packet receipt (ACK) or negative ACK (NACK).

3. The apparatus of claim 1, wherein the faulty link comprises a communicative coupling between at least two of the forwarding elements of the circuitry.

4. The apparatus of claim 1, wherein the network interface device is communicatively coupled to the circuitry and at least one processor core.

5. The apparatus of claim 1, wherein:
based on detection of a second faulty link in a third path through the forwarding elements to a second destination device, the circuitry is to direct a second packet to a fourth path within the circuitry to the second destination device and
the second packet comprises a data packet.

6. The apparatus of claim 1, comprising the forwarding element coupled to the circuitry, wherein the forwarding element comprises one or more of: a router or a switch.

7. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

8. A method comprising:
based on receipt of a packet with source routing and directed to a faulty link, a forwarding element sending the packet toward a network interface device and
the network interface device adjusting the source routing of the packet to avoid the faulty link and transmitting the packet toward a destination of the packet, wherein:
the network interface device comprises a direct memory access (DMA) circuitry, host interface to a processor, and a network interface.

9. The method of claim 8, wherein the packet comprises a control packet and/or a data packet.

10. The method of claim 8, wherein the source routing of the packet is to indicate a sequence of output ports to traverse.

11. The method of claim 8, wherein the network interface device is communicatively coupled to one or more cores.

12. The method of claim 8, wherein the forwarding element comprises one or more of: a router or a switch.

13. The method of claim 8, comprising:
the network interface device detecting the packet is to be re-directed based on a destination address of the packet not matching an address of the network interface device and
based on detecting the packet is to be re-directed and an identifier of a faulty link from the forwarding element, the network interface device adjusting the source routing of the packet to avoid the faulty link.

14. The method of claim 8, wherein the forwarding element is part of a network on chip (NoC), mesh, or off-chip network.

15. The method of claim 8, comprising:
reserving port bandwidth and buffer space for packets re-directed to avoid the faulty link and
forwarding the re-directed packet through the reserved port bandwidth and from the reserved buffer space.

16. At least one non-transitory computer-readable medium, comprising instructions stored thereon, that if executed by one or more processors, cause the one or more processors to:
configure a network interface device to:
based on receipt of a packet directed to a faulty link by source routing and received from a forwarding element, adjust source routing of the packet to avoid the faulty link and transmit the packet toward a destination of the packet, wherein the network interface device comprises a direct memory access (DMA) circuitry, host interface to a processor, and a network interface.

17. The computer-readable medium of claim 16, comprising instructions stored thereon, that if executed by one or more processors, cause the one or more processors to:
reserve port bandwidth and buffer space for packets re-directed to avoid the faulty link and
forward the re-directed packet through the reserved port bandwidth and from the reserved buffer space.

18. The computer-readable medium of claim 16, wherein the packet comprises a control packet and/or a data packet.

19. The computer-readable medium of claim 16, wherein the source routing of the packet is to indicate a sequence of output ports to traverse.

20. The computer-readable medium of claim 16, wherein the network interface device is communicatively coupled to one or more cores.
